(19) United States
(12) Patent Application Publication
(10) Pub. No.: US 2019/0134957 A1
(43) Pub. Date: May 9, 2019

(54) FILM CONSTRUCTIONS AND ARTICLES

(71) Applicant: 3M INNOVATIVE PROPERTIES COMPANY, St. Paul, MN (US)

(72) Inventors: Dylan J.V. Shallbetter, Oakdale, MN (US); Jeffrey O. Emslander, City of Grant, MN (US); Ignatius A. Kadoma, Cottage Grove, MN (US); Christopher J. Rother, Hudson, WI (US); Mark E. Schwartz, River Falls, WI (US); Jacob D. Young, St. Paul, MN (US)

(21) Appl. No.: 16/093,662

(22) PCT Filed: Apr. 19, 2017
(86) PCT No.: PCT/US2017/028396

§ 371 Date: Oct. 15, 2018

Related U.S. Application Data
(60) Provisional application No. 62/327,708, filed on Apr. 26, 2016.

(51) Int. Cl. B32B 27/08; B32B 27/28; B32B 27/30; B32B 27/32; B32B 27/36; B32B 7/12; C09J 7/29; C09J 7/40

(52) U.S. Cl. CPC B32B 27/08; C09J 2481/005; B32B 27/306; B32B 27/32; B32B 27/36; B32B 7/12; C09J 7/29; C09J 7/401; C09J 7/405; B32B 2250/03; B32B 2250/04; B32B 2250/24; B32B 2307/5825; B32B 2307/748; B32B 2405/00; C09J 2201/122; C09J 2203/31; C09J 2205/114; C09J 2423/005; C09J 2423/045; C09J 2423/046; C09J 2431/005; C09J 2431/006; C09J 2467/006; C09J 2475/005; B32B 27/283

(57) ABSTRACT

Film constructions and articles including the film constructions, wherein a film construction includes: a backing having a first major surface and a second major surface, wherein the backing includes at least one backing layer comprising a polylactic acid and an ethylene-containing copolymer comprising a polar comonomer; a tie layer disposed on the first major surface of the backing; and a release layer disposed on the tie layer.

### BACKGROUND

Traditional masking tapes have utilized paper-based backings since their invention in the first part of the 1900's. Recent advancements in technology and materials have opened new pathways to the production of polymeric-based backings for masking tape which offer several advantages over paper-based backings. Polymeric-based backings often do not need to be saturated, primed, or release coated like paper-based backings, which reduces manufacturing time, eliminates solvents from the manufacturing process, and can reduce process waste.

One of the difficulties that needs to be overcome with current polymeric-based backings is that they are often times hard to tear by hand. For masking tape, it is generally preferred to have a hand-tearable backing. Polyethylene, vinyl, and other current polymeric-backed tapes can be hard to tear by hand, and may require additional manufacturing steps to make them hand tearable.

### SUMMARY

The present disclosure is directed to film constructions and articles including such film constructions. The film constructions include a polymeric backing.

The polymeric backing includes a mixture of polylactic acid and an ethylene-containing copolymer including a polar comonomer. In this context, an ethylene-containing copolymer including a polar comonomer means that the ethylene-containing copolymer is derived from ethylene and one or more polar comonomers.

In certain embodiments, the polymeric backing is hand-tearable without additional manufacturing steps. That is, the properties of the polymeric backing generally result from the selection of the polymers combined to make the backing, as opposed to the processing steps.

In one embodiment, a film construction includes: a backing having a first major surface and a second major surface, wherein the backing includes at least one backing layer that includes polylactic acid and an ethylene-containing copolymer including a polar comonomer; a tie layer disposed on the first major surface of the backing; and a release layer disposed on the tie layer.

In one embodiment, a film construction includes: a backing having a first major surface and a second major surface, wherein the backing includes at least one backing layer that includes polylactic acid and an ethylene-containing copolymer including a polar comonomer; a tie layer disposed on the first major surface of the backing, wherein the tie layer includes an ethylene-containing copolymer including a polar comonomer (preferably, at least different two ethylene-containing copolymers, each independently including a polar comonomer); and a release layer disposed on the tie layer, wherein the release layer includes an extrudable material.

In one embodiment, a film construction includes: a backing having a first major surface and a second major surface, wherein the backing includes at least one backing layer that includes polylactic acid and an ethylene-containing copolymer including a polar comonomer; a tie layer disposed on the first major surface of the backing, wherein the tie layer includes at least two different ethylene-containing copolymers, each independently including a polar comonomer; and a release layer disposed on the tie layer, wherein the release layer includes a polyolefin, an ethylene-containing copolymer comprising a polar comonomer, a polyalkyl siloxane, a polyurethane, or a combination thereof.

In one embodiment, an adhesive layer (which may include a pressure sensitive adhesive) is disposed on the second major surface of the backing.

In one embodiment, an article is provided that includes a film construction described herein. Such articles may include a masking tape, decorative tape, box-sealing tape, decorative tape, bundling tape, medical tape, and other tapes known to those skilled in the art.

### Definitions

The term “alkyl” means a linear or branched, cyclic or acylic, saturated monovalent hydrocarbon.

The terms “includes” and “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or function specified in the disclosure for the listed elements. Thus, the phrase “consisting essentially of” indicates that the listed elements are required or mandatory, but that other elements are optional and may or may not be present depending upon whether or not they materially affect the activity or function of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. For example, a composition that includes “a” surfactant may include “one or more” surfactants.

As used herein, the term “or” is generally employed in its sense including “and/or” unless the content clearly dictates otherwise. The term “and/or” means one or all of the listed elements or a combination of any two or more of the listed elements.

As used herein, all numbers are assumed to be modified by the term “about” and in certain embodiments by the term “exactly.” Notwithstanding that the numerical ranges and parameters setting forth the broad scope of the invention are approximations, the numerical values set forth in the specific examples are reported as precisely as possible. All numerical values, however, inherently contain certain errors necessarily resulting from the standard deviation found in their respective testing measurements.

Also herein, the recitations of numerical ranges by endpoints include all numbers subsumed within that range (e.g., 1 to 5 includes 1, 1.5, 2, 2.75, 3, 3.80, 4, 5, etc.). Herein, “up to” a number (e.g., up to 50) includes the number (e.g., 50).

The term “in the range” or “within a range” (and similar statements) includes the endpoints of the stated range.

Groupings of alternative elements or embodiments disclosed herein are not to be construed as limitations. Each group member may be referred to and claimed individually or in any combination with other members of the group or other elements found therein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

When a group is present more than once in a formula described herein, each group is “independently” selected, whether specifically stated or not. For example, when more than one Y group is present in a formula, each Y group is independently selected. Furthermore, subgroups contained within these groups are also independently selected. For example, when each Y group contains an R, then each R is also independently selected.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in one or more embodiments.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIG. 1 is a cross-sectional representation of an exemplary film construction with an optional adhesive layer disposed thereon (wherein the layers are not necessarily to scale).

### DETAILED DESCRIPTION OF ILLUSTRATIVE EMBODIMENTS

The present disclosure is directed to film constructions and articles including such film constructions, such as masking tapes.

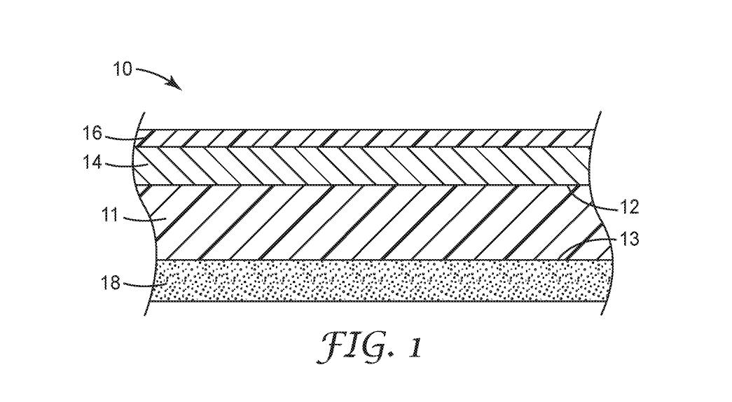

As shown in FIG. 1, in one embodiment of the present disclosure there is provided a film construction 10 having a backing 11 that has a first major surface 12 and a second major surface 13. The backing 11 may include one or more layers (not specifically shown) as long as at least one of the backing layers includes a mixture of polylactic acid and an ethylene-containing copolymer including a polar comonomer. Disposed on the first major surface 12 of the backing 11 is a tie layer 14, and disposed on the tie layer 14 is a release layer 16. In certain embodiments, disposed on the second major surface 13 of the backing 11 is an adhesive layer 18 (e.g., a pressure sensitive adhesive).

In certain embodiments, the tie layer includes at least two different ethylene-containing copolymers, each independently including a polar comonomer.

In certain embodiments, the release layer includes an extrudable material. In certain embodiments, the extrudable material of the release layer includes a polyolefin, an ethylene-containing copolymer comprising a polar comonomer, a polyalkyl siloxane, a polyurethane, or a combination thereof.

The backing may optionally contain additional layers that include materials other than a mixture of PLA and an ethylene-containing copolymer.

Typically, such film constructions (i.e., films) that include a backing, release layer, and tie layer that bonds or ties the backing and release layer together are formed by coextruding the backing, release layer, and tie layer. Typically, such film constructions need no further processing after extrusion to make them hand-tearable films for use in articles such as hand-tearable tapes.

In certain embodiments, a film construction of the present disclosure possesses one or more of the following properties:

(a) a tearability of less than 500 milliNewtons (according to the ASTM D1922 (2015) with a direction of tear perpendicular to the length of the sample);

(b) an elongation of less than 5% (according to ASTM D3759 (2011));

(c) a tensile strength of less than 0.54 kilogram per millimeter (kg/mm) (according to ASTM D3759 (2011));

(d) a release force of 0.8 kg/25 mm or less (or 0.7 kg/25 mm or less, or 0.6 kg/25 mm or less) (according to the Release Force (180 Degree Angle) Test of the Examples Section); and/or

(e) a haze value of less than 40% (according to ASTM D1003 (2013)). Film constructions with such properties are typically hand tearable in the cross direction while retaining down web strength, and are relatively optically clear.

### Backing

In certain embodiments, a backing of the present disclosure possesses a tearability of less than 500 milliNewtons according to ASTM D1922 (2015), an elongation of less than 5% according to ASTM D3759 (2011), a tensile strength of less than 0.54 kg/mm according to ASTM D3759 (2011), and/or a haze value of less than 40% according to ASTM D1003 (2013). Such properties of a backing and a film construction are very similar. It is believed this is so because the thickness of the backing layer (e.g., 40-83 micrometers) is relatively large compared to the thicknesses of the tie layer (e.g., 5-15 micrometers) and the release layer (e.g., 5-15 micrometers). Therefore, the properties of the entire film construction are dominated by the properties of the backing layer. Thus, evaluation of a film construction provides information about the properties of the backing of such film construction.

A backing of the present disclosure includes at least one backing layer that includes a mixture of at least polylactic acid (“PLA” or polylactic acid polymer) and an ethylene-containing copolymer including a polar comonomer. In certain embodiments, all the layers of the backing include such mixture. Typically, PLA alone is stiff and brittle, and an ethylene-containing copolymer such as ethylene/vinyl acetate elongates upon tearing. Together, however, the combination provides good properties for a hand-tearable tape.

The backing may also include optional layers including other materials such as 100 wt-% PLA, 100 wt-% of one or more ethylene-containing copolymers comprising a polar comonomer, as well as layers that include polyurethanes, polyesters, polyamides, polyolefins (e.g., polyethylene, polypropylene), and combinations thereof. Such optional layers may be employed so long as the film retains its desirable properties, such as desirable tearability characteristics and internal cohesive integrity (e.g., does not suffer from delamination during manufacture or use).

Lactic acid is a renewable material obtained by the bacterial fermentation of corn starch or cane sugar, and thus is considered a natural or in other words “biomass” material. Lactic acid has two optical isomers: L-lactic acid (also known as (S)-lactic acid) and D-lactic acid (also known as (R)-lactic acid), depicted as follows:

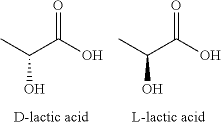

Polyesterification of lactic acid affords polylactic acid polymer.

More typically, n moles of lactic acid is typically converted to the cyclic lactide monomer, and the lactide undergoes ring opening polymerization, such as depicted as follows (wherein n is at least 2):

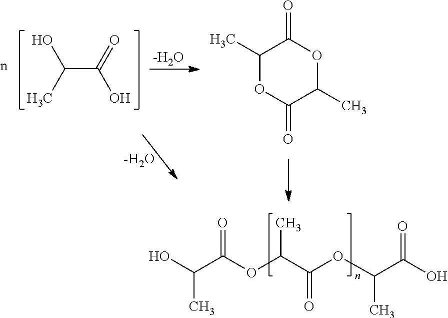

The resulting polymer material is typically referred to as polylactide polymer or polylactic acid polymer or simply polylactic acid (or PLA).

The degree of crystallinity, and hence many important properties, is largely controlled by the ratio of D- and/or meso-lactide to L-cyclic lactide monomers used. Likewise, for polymers prepared by direct polyesterification of lactic acid, the degree of crystallinity is largely controlled by the ratio of polymerized units derived from D-lactic acid to polymerized units derived from L-lactic acid.

The backing layers described herein that include PLA generally include an amorphous PLA polymer alone or in combination with a semicrystalline PLA polymer. Both the semicrystalline and amorphous PLA polymers have differing concentrations of polymerized units derived from L-lactic acid (e.g., L-lactide) and polymerized units derived from D-lactic acid (e.g., D-lactide). Typically, the polylactic acid of the backing includes at least 1 weight percent (wt-%) D-lactic acid.

The amorphous PLA typically includes up to 90 wt-%, or up to 88 wt-%, or up to 86 wt-% of polymerized units derived from L-lactic acid, and at least 10 wt-% of polymerized units derived from D-lactic acid (e.g., D-lactic lactide and/or meso-lactide). In some embodiments, the amorphous PLA comprises at least 80 wt-%, or at least 82 wt-%, or at least 84 wt-%, or at least 85 wt-% of polymerized units derived from L-lactic acid (e.g., L-lactide). In some embodiments, the amorphous PLA comprises up to 20 wt-%, or up to 15 wt-%. of polymerized units derived from D-lactic acid (e.g. D-lactide and/or meso-lactide). A suitable amorphous PLA includes INGEO 4060D available from NatureWorks Incorporated. This polymer has been described in the literature to have a molecular weight Mw of 180,000 g/mole.

A backing layer may further include a semicrystalline PLA polymer blended with the amorphous PLA.

The semicrystalline PLA polymer typically includes at least 90 wt-%, at least 92 wt-%, at least 94 wt-%, or at least 95 wt-% of polymerized units derived from L-lactic acid (e.g., L-lactide), and up to 10 wt-%, up to 9 wt-%, up to 8 wt-%, up to 7 wt-%, up to 6 wt-%, or up to 5 wt-% of polymerized units derived from D-lactic acid (e.g., D-lactide and/or meso-lactide). In yet other embodiments, the semicrystalline PLA polymer comprises at least 96 wt-% of polymerized units derived from L-lactic acid (e.g., L-lactide), and up to 4 wt-%, up to 3 wt-%, or up to 2 wt-% of polymerized units derived from D-lactic acid (e.g., D-lactide and/or meso-lactide). Suitable examples of semicrystalline PLA include INGEO 4042D and 4032D available from NatureWorks Incorporated. These polymers have been described in the literature as having a weight average molecular weight (Mw) of 200,000 grams per mole (g/mole or g/mol); a number average molecular weight (Mn) of 100,000 g/mole; and a polydispersity of 2.0.

The PLA polymers are preferably “film grade” polymers, having a melt flow rate (as measured according to ASTM D1238) of up to 25 grams per minute (g/min), up to 20 g/min, up to 15 g/min, or up to 10 g/min, at 210° C. with a mass of 2.16 kilograms (kg). In some embodiments, the PLA polymer has a melt flow rate of less than 10 g/min or less than 9 g/min at 210° C. The melt flow rate is related to the molecular weight of the PLA polymer. The PLA polymer typically has a weight average molecular weight (Mw) as determined by Gel Permeation Chromatography with polystyrene standards of at least 50,000 g/mol, at least 75,000 g/mol, at least 100,000 g/mol, at least 125,000 g/mol, or at least 150,000 g/mol. In some embodiments, the molecular weight (Mw) is up to 400,000 g/mol, up to 350,000 g/mol, or up to 300,000 g/mol.

The PLA polymers typically have a tensile strength ranging from 25 megapascals (MPa) to 150 MPa; a tensile modulus ranging from 1000 MPa to 7500 MPa; and a tensile elongation of at least 3%, at least 4%, or at least 5%, ranging up to about 15%. In some embodiments, the tensile strength of the PLA polymer is at least 30 MPa, at least 40 MPa, or at least 50 MPa. In some embodiments, the tensile strength of the PLA polymer is up to 125 MPa, up to 100 MPa, or up to 75 MPa. In some embodiments, the tensile modulus of the PLA polymer is at least 1500 MPa, at least 2000 MPa, or at least 2500 MPa. In some embodiments, the tensile modulus of the PLA polymer is up to 7000 MPa, up to 6500 MPa, up to 6000 MPa, up to 5500 MPa, up to 5000 MPa, or up to 4000 MPa. Such tensile and elongation properties can be determined by ASTM D882 and are typically reported by the manufacturer or supplier of such PLA polymers.

The semicrystalline and amorphous PLA polymers generally have a glass transition temperature, Tg, as can be determined by Differential Scanning Calorimetry (DSC) ranging from 50° C. to 65° C. The semicrystalline PLA polymers typically have a melting point ranging from 140° C. to 175° C.

The PLA polymer, typically an amorphous PLA alone or in combination with a semicrystalline PLA polymer can, be melt-processed at temperatures of 180° C., 190° C., 200° C., 210° C., 220° C., or 230° C.

A backing of the present disclosure typically includes an amorphous PLA polymer or a blend of amorphous and semicrystalline PLA polymers in a total amount of at least 40 wt-%, at least 45 wt-%, at least 50 wt-%, at least 55 wt-%, at least 60 wt-%, at least 65 wt-%, at least 70 wt-%, at least 75 wt-%, or at least 80 wt-%, based on the total weight of the PLA and ethylene-containing copolymer. The total amount of PLA polymer is typically up to 99 wt-%, up to 95 wt-%, up to 90 wt-%, up to 85 wt-%, up to 80 wt-%, up to 75 wt-%, or up to 70 wt-% of the total weight of the PLA and ethylene-containing copolymer.

When the composition comprises a blend of amorphous and semicrystalline PLA, the amount of amorphous PLA is typically at least 10 wt-%, at least 15 wt-%, or at least 20 wt-%, based on the total weight of the PLA polymer and ethylene-containing copolymer. In some embodiments, the amount of semicrystalline PLA polymer ranges from at least 10 wt-%, at least 15 wt-%, at least 25 wt-%, or at least 30 wt-%, and up to 50 wt-%, up to 55 wt-%, or up to 60 wt-%, based on the total weight of the PLA polymer and ethylene-containing copolymer. The amount of amorphous PLA polymer is typically greater than the amount of semicrystalline polymer.

A backing layer also includes an ethylene-containing copolymer including a polar comonomer. In certain embodiments, an ethylene-containing copolymer that includes a polar comonomer (i.e., an ethylene-containing copolymer) is typically selected to combine with the PLA selected to provide flexibility and tearability to the backing. In certain embodiments, an ethylene-containing copolymer is also selected to be compatible with the PLA selected such that there are no microdomains that could provide a hazy backing layer.

Suitable copolymers may have a melt flow index according to ASTM D1238 of at least 1 g/10 min, at least 2 g/10 min, at least 5 g/10 min, or at least 10 g/10 min. In some embodiments, the melt flow index is up to 100 g/10 min, up to 80 g/10 min, up to 60 g/10 min, or up to 40 g/10 min.

In certain embodiments, the ethylene-containing copolymer including a polar comonomer of a backing layer includes at least 70 wt-%, at least 75 wt-%, or at least 80 wt-% of ethylene. In certain embodiments, the ethylene-containing copolymer including a polar comonomer of a backing layer includes up to 99 wt-%, up to 95 wt-%, up to 90 wt-%, or up to 85 wt-% of ethylene.

In certain embodiments, the ethylene-containing copolymer including a polar comonomer of a backing layer includes at least 1 wt-%, at least 5 wt-%, at least 10 wt-%, or at least 15 wt-%, of one or more polar comonomers. In certain embodiments, the ethylene-containing copolymer including a polar comonomer of a backing layer includes up to 30 wt-%, up to 25 wt-%, or up to 20 wt-%, of one or more polar comonomers.

Examples of ethylene-containing copolymers including a polar comonomer include ethylene/vinyl acetate, ethylene/acrylic acid, ethylene/methacrylic acid, and the like. Ethylene/vinyl acetate copolymers are commercially available from various suppliers including DuPont Packaging and Industrial Polymers under the trade designations ELVAX 750, 550, and 350. Ethylene/acrylic acid copolymers are available from various suppliers such as Dow under the trade designation PRIMACOR 1410 or 3460. Ethylene/methacrylic acid copolymers are available from various suppliers such as DuPont Packaging and Industrial Polymers under the trade designations NUCREL 0403 and 0903.

In certain embodiments, the ethylene-containing copolymer including a polar comonomer may be modified. In this context, “modified” means an ethylene-containing copolymer containing two or more polar comonomers (in contrast to an “unmodified” ethylene-containing copolymer, which includes ethylene and just one polar comonomer). Examples of modified ethylene-containing copolymers include carbon monoxide modified ethylene/vinyl acetate or anhydride modified ethylene/vinyl acetate. Modified ethylene-containing copolymers are commercially available from various suppliers including DuPont Packaging and Industrial Polymers under the trade designations BYNEL E418 and ELVALOY 741.

In certain embodiments, the backing layer may contain a mixture of at least two different ethylene-containing copolymers. In certain embodiments, the at least two different ethylene-containing copolymers may each independently include different polar comonomers. In certain embodiments, the at least two different ethylene-containing copolymers may each independently include the same polar comonomers but with different polar comonomer levels. In certain embodiments, the at least two different ethylene-containing copolymers may each independently include an unmodified ethylene-containing copolymer and a modified ethylene-containing copolymer (as described herein).

In certain embodiments the at least one backing layer includes a total amount of at least 1 wt-%, at least 2 wt-%, at least 3 wt-%, at least 4 wt-%, or at least 5 wt-%, ethylene-containing copolymer including a polar comonomer, based on the total weight of PLA and ethylene-containing copolymer including a polar comonomer. In certain embodiments the at least one backing layer includes a total amount of up to 20 wt-%, up to 15 wt-%, or up to 10 wt-%, ethylene-containing copolymer including a polar comonomer, based on the total weight of PLA and ethylene-containing copolymer including a polar comonomer.

In certain embodiments, a backing layer may include optional additives such as UV stabilizers, fillers, colorants, and the like.

### Release Layer

In a film construction of the present disclosure, a release layer includes an extrudable material. Exemplary extrudable materials include a polyolefin, an ethylene-containing copolymer including a polar comonomer, a polyalkyl siloxane, a polyurethane, or a combination thereof.

In certain embodiments, a release layer includes a polyolefin. In certain embodiments, the polyolefin in the release layer is a low density polyethylene. In this context, “low density” means less than 0.93 grams per cubic centimeter (g/cc or g/cm³).

An olefin suitable for use in a release layer may have a melt flow index according to ASTM D1238 of at least 1 g/10 min, at least 2 g/10 min, at least 5 g/10 min or at least 10 g/10 min. In some embodiments, the melt flow index is up to 100 g/10 min, up to 80 g/10 min, up to 60 g/10 min, or up to 40 g/10 min.

Examples of polyolefins include polyethylene, polypropylene, poly-alpha-olefins, and copolymers thereof, including low density polyethylene (LDPE), high density polyethylene (HDPE), linear low density polyethylene (LLDPE), ultra-high density polyethylene (UHDPE), and polyethylene-polypropylene copolymers. Polyolefins are commercially available from various suppliers including Eqiustar Chemicals, LP of LyondellBasell Holdings under the trade designation PETROTHENE.

In certain embodiments a release layer also includes an ethylene-containing copolymer including a polar comonomer. Such copolymers may have a melt flow index according to ASTM D1238 of at least 1 g/10 min, at least 2 g/10 min, at least 5 g/10 min, or at least 10 g/10 min. In some embodiments, the melt flow index is up to 100 g/10 min, up to 80 g/10 min, up to 60 g/10 min, or up to 40 g/10 min.

In certain embodiments, the ethylene-containing copolymer including a polar comonomer of the release layer includes at least 70 wt-%, at least 75 wt-%, or at least 80 wt-% of ethylene. In certain embodiments, the ethylene-containing copolymer including a polar comonomer of the release layer includes up to 99 wt-%, up to 95 wt-%, up to 90 wt-%, or up to 85 wt-% of ethylene.

In certain embodiments, the ethylene-containing copolymer including a polar comonomer of the release layer includes at least 1 wt-%, at least 5 wt-%, at least 10 wt-%, or at least 15 wt-%, of one or more polar comonomers. In certain embodiments, the ethylene-containing copolymer including a polar comonomer of the release layer includes up to 30 wt-%, up to 25 wt-%, or up to 20 wt-%, of one or more polar comonomers.

Examples of ethylene-containing copolymers including a polar comonomer include ethylene/vinyl acetate, ethylene/acrylic acid, ethylene/methacrylic acid, and the like. Ethylene/vinyl acetate copolymers are commercially available from various suppliers including DuPont Packaging and Industrial Polymers under the trade designations ELVAX 750, 550, and 350. Ethylene/acrylic acid copolymers are available from various suppliers such as Dow under the trade designations PRIMACOR 1410 and 3460. Ethylene/methacrylic acid copolymers are available from various suppliers such as DuPont Packaging and Industrial Polymers under the trade designations NUCREL 0403 and 0903.

In certain embodiments, the ethylene-containing copolymer including a polar comonomer may be modified. In this context, “modified” means an ethylene-containing copolymer containing two or more polar comonomers (in contrast to an “unmodified” ethylene-containing copolymer, which includes ethylene and just one polar comonomer). Examples of modified ethylene-containing copolymers include carbon monoxide modified ethylene/vinyl acetate or anhydride modified ethylene/vinyl acetate. Modified ethylene-containing copolymers are commercially available from various suppliers including DuPont Packaging and Industrial Polymers under the trade designations BYNEL E418 and ELVALOY 741.

In certain embodiments, the release layer may contain a mixture of at least two different ethylene-containing copolymers. In certain embodiments, the at least two different ethylene-containing copolymers may each independently include different polar comonomers. In certain embodiments, the at least two different ethylene-containing copolymers may each independently include the same polar comonomers but with different polar comonomer levels. In certain embodiments, the at least two different ethylene-containing copolymers may each independently include an unmodified ethylene-containing copolymer and a modified ethylene-containing copolymer (as described herein).

In certain embodiments, the release layer includes a polyalkyl siloxane. In certain embodiments, a polyalkyl siloxane has a structure that includes:

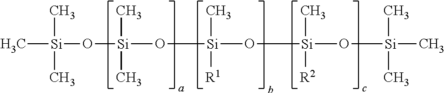

wherein:
the sum of (a+b+c) is from 100 to 1000;
the ratio of a to the sum of (b+c) is from 98:2 to 94:6;
R¹ is a linear, branched, or cyclic alkyl group having from 20 to 50 carbon atoms; and
R² is a linear, branched, or cyclic alkyl or alkaryl group having from 6 to 10 carbon atoms.

In certain embodiments, the release layer includes a polyurethane. A polyurethane compound suitable for use in a release layer has a weight or number average molecular weight (as determined by Gel Permeation Chromatography with polystyrene standards) of at least 30,000 g/mol, at least 60,000 g/mol, or at least 70,000 g/mol. In some embodiments, the molecular weight (Mw) is up to 300,000 g/mol, up to 250,000 g/mol, or up to 200,000 g/mol.

An example of a polyurethane compound includes polyvinyl octadecyl carbamate. Polyurethanes are commercially available from various suppliers including Mayzo Incorporated under the trade designation ESOCOAT P20.

In certain embodiments, a release layer includes a polyolefin. In certain embodiments, a release layer includes a polyolefin and a polyalkyl siloxane. In certain embodiments, a release layer includes a polyolefin, an ethylene-containing copolymer including a polar comonomer, and a polyalkyl siloxane. In certain embodiments, a release layer includes a polyolefin, an ethylene-containing copolymer including a polar comonomer, and a polyurethane.

In certain embodiments, a polyolefin may be used in a wide variety of amounts bewteen 1 wt-% and 99 wt-% (including the endpoints). For example, a polyolefin may be present in a release layer in an amount of up to 99 wt-%, up to 98 wt-%, up to 95 wt-%, up to 90 wt-%, up to 85 wt-%, up to 80 wt-%, up to 75 wt-%, up to 70 wt-%, up to 65 wt-%, up to 60 wt-%, up to 55 wt-%, or up to 50 wt-%, based on the total weight of the release layer. In certain embodiments, a polyolefin may be present in a release layer in an amount of at least 1 wt-%, at least 2 wt-%, at least 3 wt-%, at least 4 wt-%, at least 5 wt-%, at least 6 wt-%, at least 7 wt-%, at least 8 wt-%, at least 9 wt-%, or at least 10 wt-%, based on the total weight of the release layer.

In certain embodiments, a release layer includes a mixture that includes a polyolefin, an ethylene-containing copolymer including a polar comonomer, and a polyalkyl siloxane.

In certain embodiments, the polyalkyl siloxane is present in the release layer in an amount of up to 5 wt-%, up to 4 wt-%, or up to 3 wt-%, based on the total weight of the release layer. In certain embodiments, the polyalkyl siloxane is present in the release layer in an amount of at least 0.5 wt-%, at least 1 wt-%, based on the total weight of the release layer.

In certain embodiments, the ethylene-containing copolymer is present in the mixture with a polyolefin and a polyalkyl siloxane in the release layer in an amount of up to 97 wt-%, up to 95 wt-%, or up to 90 wt-%, based on the total weight of the release layer. In certain embodiments, the ethylene-containing copolymer is present in the mixture with a polyolefin and a polyalkyl siloxane in the release layer in an amount of at least 70 wt-%, or at least 80 wt-%, based on the total weight of the release layer.

In certain embodiments, the polyolefin is present in the mixture with an ethylene-containing copolymer and a polyalkyl siloxane in the release layer in an amount of up to 25 wt-%, up to 20 wt-%, or up to 15 wt-%, based on the total weight of the release layer. In certain embodiments, the polyolefin is present in the mixture with an ethylene-containing copolymer and a polyalkyl siloxane in the release layer in an amount of at least at least 2 wt-%, at least 2.5 wt-%, at least 3 wt-%, at least 5 wt-%, at least 8 wt-%, or at least 10 wt-%, based on the total weight of the release layer.

In certain embodiments, the release layer includes a mixture including a polyolefin, an ethylene-containing copolymer including a polar comonomer, and a polyurethane.

In certain embodiments, the polyolefin is present in the mixture with an ethylene-containing copolymer and a polyurethane in the release layer in an amount of up to 85 wt-%, up to 80 wt-%, up to 75 wt-%, up to 70 wt-%, up to 65 wt-%, up to 60 wt-%, up to 55 wt-%, or up to 50 wt-%, based on the total weight of the release layer. In certain embodiments, the polyolefin is present in the mixture with an ethylene-containing copolymer and a polyurethane in the release layer in an amount of at least 2 wt-%, at least 5 wt-%, at least 10 wt-%, at least 15 wt-%, at least 20 wt-%, at least 25 wt-%, at least 30 wt-%, at least 35 wt-%, or at least 40 wt-%, based on the total weight of the release layer.

In certain embodiments, the polyurethane is present in the mixture with an ethylene-containing copolymer and a polyolefin in the release layer in an amount of up to 50 wt-%, up to 45 wt-%, up to 40 wt-%, up to 35 wt-%, up to 30 wt-%, up to 25 wt-%, or up to 20 wt-%, based on the total weight of the release layer. In certain embodiments, the polyurethane is present in the mixture with an ethylene-containing copolymer and a polyolefin in the release layer in an amount of at least 1 wt-%, at least 5 wt-%, at least 10 wt-%, at least 15 wt-%, at least 20 wt-%, at least 25 wt-%, or at least 30 wt-%, based on the total weight of the release layer.

In certain embodiments, the ethylene-containing copolymer is present in the mixture with a polyolefin and a polyurethane in the release layer in an amount of up to 90 wt-%, or up to 80 wt-%, up to 70 wt-%, up to 60 wt-%, up to 50 wt-%, up to 40 wt-%, or up to 30 wt-%, based on the total weight of the release layer. In certain embodiments, the ethylene-containing copolymer is present in the mixture with a polyolefin and a polyurethane in the release layer in an amount of at least 5 wt-%, at least 10 wt-%, at least 15 wt-%, or at least 20 wt-%, based on the total weight of the release layer.

### Tie Layer

A film construction of the present disclosure includes a layer that ties the release layer to the backing.

In certain embodiments a tie layer includes an ethylene-containing copolymer including a polar comonomer. Such copolymers may have a melt flow index according to ASTM D1238 of at least 1 g/10 min, at least 2 g/10 min, at least 5 g/10 min or at least 10 g/10 min. In some embodiments, the melt flow index is up to 100 g/10 min, up to 80 g/10 min, up to 60 g/10 min, or up to 40 g/10 min.

In certain embodiments, the ethylene-containing copolymer including a polar comonomer of the tie layer includes at least 70 wt-%, at least 75 wt-%, or at least 80 wt-% of ethylene. In certain embodiments, the ethylene-containing copolymer including a polar comonomer of the tie layer includes up to 99 wt-%, up to 95 wt-%, up to 90 wt-%, or up to 85 wt-% of ethylene.

In certain embodiments, the ethylene-containing copolymer including a polar comonomer of the tie layer includes at least 1 wt-%, at least 5 wt-%, at least 10 wt-%, or at least 15 wt-%, of one or more polar comonomers. In certain embodiments, the ethylene-containing copolymer including a polar comonomer of the tie layer includes up to 30 wt-%, up to 25 wt-%, or up to 20 wt-%, of one or more polar comonomers.

Examples of ethylene-containing copolymers including a polar comonomer include ethylene/vinyl acetate, ethylene/acrylic acid, and ethylene/methacrylic acid and the like. Ethylene/vinyl acetate copolymers are commercially available from various suppliers including DuPont Packaging and Industrial Polymers under the trade designations ELVAX 750, 550, and 350. Ethylene/acrylic acid copolymers are available from various suppliers such as Dow under the trade designations PRIMACOR 1410 and 3460. Ethylene/methacrylic acid copolymers are available from various suppliers such as DuPont Packaging and Industrial Polymers under the trade designations NUCREL 0403 and 0903.

In certain embodiments, the ethylene-containing copolymer including a polar comonomer may be modified. In this context, “modified” means an ethylene-containing copolymer containing two or more polar comonomers (in contrast to an “unmodified” ethylene-containing copolymer, which includes ethylene and just one polar comonomer). Examples of modified ethylene-containing copolymers include carbon monoxide modified ethylene/vinyl acetate or anhydride modified ethylene/vinyl acetate. Modified ethylene-containing copolymers are commercially available from various suppliers including DuPont Packaging and Industrial Polymers under the trade designations BYNEL E418 and ELVALOY 741.

In certain embodiments, the tie layer may contain a mixture of at least two different ethylene-containing copolymers. In certain embodiments, the at least two different ethylene-containing copolymers may each independently include different polar comonomers. In certain embodiments, the at least two different ethylene-containing copolymers may each independently include the same polar comonomers but with different polar comonomer levels. In certain embodiments, the at least two different ethylene-containing copolymers may each independently include an unmodified ethylene-containing copolymer and a modified ethylene-containing copolymer.

In certain embodiments, each of the backing and tie layer and release layer include an ethylene-containing copolymer. In such embodiments, the ethylene-containing copolymers of each layer may or may not be the same.

### Articles

Articles are provided that include film constructions of the present disclosure. In certain embodiments, an adhesive layer is disposed on a backing (typically the second major surface of the backing).

In certain embodiments, the adhesive layer includes a pressure sensitive adhesive. The adhesive may be applied by traditional coating methods, such as by solvent, water-based, transfer lamination, or hot melt extrusion or coextrusion. Examples of pressure sensitive adhesives include, but are not limited to, rubbers based on isoprene, butyl, isobutylene; synthetic rubbers (eg., based on block copolymers); acrylates; silicones; and vinyl ethers.

In certain embodiments, the article is a hand-tearable tape. Such tapes could be useful as a masking tape, box sealing tape, bundling tape, medical tape, and other tapes known to those skilled in the art.

### ILLUSTRATIVE EMBODIMENTS

Embodiment 1 is a film construction comprising: a backing having a first major surface and a second major surface, wherein the backing comprises at least one backing layer comprising a mixture of polylactic acid and an ethylene-containing copolymer comprising a polar comonomer; a tie layer disposed on the first major surface of the backing; and a release layer disposed on the tie layer.

Embodiment 2 is the film construction of embodiment 1 wherein the tie layer comprises a mixture of at least two different ethylene-containing copolymers each independently comprising a polar comonomer.

Embodiment 3 is the film construction of embodiment 2 wherein the at least two different ethylene-containing copolymers each independently comprises a different polar comonomer or the same polar comonomer in different amounts.

Embodiment 4 is the film construction of embodiment 2 or 3 wherein the at least two different ethylene-containing copolymers comprises a modified ethylene-containing copolymer, an unmodified ethylene-containing copolymer, or a combination thereof.

Embodiment 5 is the film construction of any of embodiments 1 through 4 wherein the release layer comprises an extrudable material.

Embodiment 6 is the film construction of embodiment 5 wherein the extrudable material comprises a polyolefin, an ethylene-containing copolymer comprising a polar comonomer, a polyalkyl siloxane, a polyurethane, or a combination thereof.

Embodiment 7 is the film construction of any of embodiments 1 through 6 wherein the ethylene-containing copolymer comprising a polar comonomer of any of a backing layer, tie layer, and/or release layer comprises a modified ethylene-containing copolymer comprising a polar comonomer.

Embodiment 8 is the film construction of any of embodiments 1 through 7 wherein the release layer comprises a polyolefin.

Embodiment 9 is the film construction of embodiment 8 wherein the release layer comprises a mixture comprising: a polyolefin; an ethylene-containing copolymer comprising a polar comonomer; and either a polyalkyl siloxane or a polyurethane.

Embodiment 10 is the film construction of embodiment 8 or 9 wherein the polyolefin in the release layer comprises a low density polyethylene.

Embodiment 11 is the film construction of embodiment 9 or 10 wherein the release layer comprises a mixture comprising: a polyolefin; an ethylene-containing copolymer comprising a polar comonomer; and a polyalkyl siloxane.

Embodiment 12 is the film construction of embodiment 11 wherein the polyalkyl siloxane in the release layer has a structure comprising:

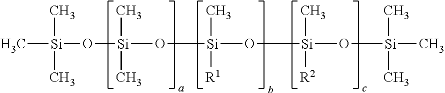

wherein:
the sum of (a+b+c) is from 100 to 1000;
the ratio of a to the sum of (b+c) is from 98:2 to 94:6;
R¹ is a linear, branched, or cyclic alkyl group having from 20 to 50 carbon atoms; and
R² is a linear, branched, or cyclic alkyl or alkaryl group having from 6 to 10 carbon atoms.

Embodiment 13 is the film construction of embodiment 11 or 12 wherein the polyalkyl siloxane is present in the release layer in an amount of up to 5 wt-%, based on the total weight of the release layer.

Embodiment 14 is the film construction of any of embodiments 11 through 13 wherein the polyalkyl siloxane is present in the release layer in an amount of at least 0.5 wt-%, based on the total weight of the release layer.

Embodiment 15 is the film construction of any of embodiments 11 through 14 wherein the ethylene-containing copolymer comprising a polar comonomer is present in the mixture with a polyolefin and a polyalkyl siloxane in the release layer in an amount of up to 97 wt-%, based on the total weight of the release layer.

Embodiment 16 is the film construction of any of embodiments 11 through 15 wherein the ethylene-containing copolymer comprising a polar comonomer is present in the mixture with a polyolefin and a polyalkyl siloxane in in the release layer in an amount of at least 70 wt-%, based on the total weight of the release layer.

Embodiment 17 is the film construction of any of embodiments 11 through 16 wherein the polyolefin is present in the mixture with an ethylene-containing copolymer comprising a polar comonomer and a polyalkyl siloxane in the release layer in an amount of up to 25 wt-%, based on the total weight of the release layer.

Embodiment 18 is the film construction of any of embodiments 11 through 17 wherein the polyolefin is present in the mixture with an ethylene-containing copolymer comprising a polar comonomer and a polyalkyl siloxane in the release layer in an amount of at least 2 wt-%, based on the total weight of the release layer.

Embodiment 19 is the film construction of embodiment 9 or 10 wherein the release layer comprises a mixture comprising: a polyolefin; an ethylene-containing copolymer comprising a polar comonomer; and a polyurethane.

Embodiment 20 is the film construction of embodiment 19 wherein the polyolefin is present in the mixture with an ethylene-containing copolymer comprising a polar comonomer, and a polyurethane, in the release layer in an amount of up to 85 wt-%, based on the total weight of the release layer.

Embodiment 21 is the film construction of embodiment 19 or 20 wherein the polyolefin is present in the mixture with an ethylene-containing copolymer comprising a polar comonomer, and a polyurethane, in the release layer in an amount of at least 2 wt-%, based on the total weight of the release layer.

Embodiment 22 is the film construction of any of embodiments 19 through 21 wherein the polyurethane is present in the mixture with an ethylene-containing copolymer comprising a polar comonomer, and a polyolefin, in the release layer in an amount of up to 50 wt-%, based on the total weight of the release layer.

Embodiment 23 is the film construction of any of embodiments 19 through 22 wherein the polyurethane is present in the mixture with an ethylene-containing copolymer comprising a polar comonomer, and a polyolefin, in the release layer in an amount of at least 1 wt-%, based on the total weight of the release layer.

Embodiment 24 is the film construction of any of embodiments 19 through 23 wherein the ethylene-containing copolymer comprising a polar comonomer is present in the mixture with a polyolefin and a polyurethane in the release layer in an amount of up to 90 wt-%, based on the total weight of the release layer.

Embodiment 25 is the film construction of any of embodiments 19 through 24 wherein the ethylene-containing copolymer comprising a polar comonomer is present in the mixture with a polyolefin and a polyurethane in the release layer in an amount of at least 5 wt-%, based on the total weight of the release layer.

Embodiment 26 is the film construction of any of embodiments 1 through 25 wherein the backing possesses a tearability of less than 500 milliNewtons according to ASTM D1922 (2015).

Embodiment 27 is the film construction of any of embodiments 1 through 26 wherein the backing possesses an elongation of less than 5% according to ASTM D3759 (2011).

Embodiment 28 is the film construction of any of embodiments 1 through 27 wherein the backing possesses a tensile strength of less than 0.54 kg/mm according to ASTM D3759 (2011).

Embodiment 29 is the film construction of any of embodiments 1 through 28 wherein the backing possesses a haze value of less than 40% according to ASTM D1003 (2013).

Embodiment 30 is the film construction of any of embodiments 1 through 29 wherein the polylactic acid of the backing comprises at least 1 wt-% D-lactic acid.

Embodiment 31 is the film construction of any of embodiments 1 through 30 wherein the polylactic acid of the backing comprises amorphous polyactic acid and optionally semicrystalline polylactic acid.

Embodiment 32 is the film construction of any of embodiments 1 through 31 wherein the ethylene-containing copolymer comprising a polar comonomer of each backing layer comprises at least 1 wt-% of one or more polar comonomers.

Embodiment 33 is the film construction of any of embodiments 1 through 32 wherein the ethylene-containing copolymer comprising a polar comonomer of each backing layer comprises up to 30 wt-% of one or more polar comonomers.

Embodiment 34 is the film construction of any of embodiments 1 through 33 wherein each backing layer comprises at least 1 wt-% ethylene-containing copolymer comprising a polar comonomer, based on the total weight of polylactic acid and ethylene-containing copolymer comprising a polar comonomer.

Embodiment 35 is the film construction of any of embodiments 1 through 34 wherein each backing layer comprises up to 20 wt-% ethylene-containing copolymer comprising a polar comonomer, based on the total weight of polylactic acid and ethylene-containing copolymer comprising a polar comonomer.

Embodiment 36 is the film construction of any of embodiments 1 through 35 which possesses a tearability of less than 500 milliNewtons according to the ASTM D1922 (2015).

Embodiment 37 is the film construction of any of embodiments 1 through 36 which possesses an elongation of less than 5% according to ASTM D3759 (2011).

Embodiment 38 is the film construction of any of embodiments 1 through 37 which possesses a tensile strength of less than 0.54 kg/mm according to ASTM D3759 (2011).

Embodiment 39 is the film construction of any of embodiments 1 through 38 which possesses a release force of 0.8 kg/25 mm or less (or 0.7 kg/25 mm or less, or 0.6 kg/25 mm or less).

Embodiment 40 is the film construction of any of embodiments 1 through 39 which possesses a haze value of less than 40% according to ASTM D1003 (2013).

Embodiment 41 is an article comprising the film construction of any of embodiments 1 through 40.

Embodiment 42 is the article embodiment 41 further comprising an adhesive layer disposed on the second major surface of the backing.

Embodiment 43 is the article of embodiment 42 wherein the adhesive layer comprises a pressure sensitive adhesive.

Embodiment 44 is the article of any of embodiments 41 through 43 which is a masking tape, a box-sealing tape, a bundling tape, a decorative tape, or a medical tape.

Embodiment 45 is a film construction comprising: a backing having a first major surface and a second major surface, wherein the backing comprises at least one backing layer comprising a mixture of polylactic acid and an ethylene-containing copolymer comprising a polar comonomer; a tie layer disposed on the first major surface of the backing, wherein the tie layer comprises at least two different ethylene-containing copolymers each independently comprising a polar comonomer; and a release layer disposed on the tie layer, wherein the release layer comprises an extrudable material.

Embodiment 46 is a film construction comprising: a backing having a first major surface and a second major surface, wherein the backing comprises at least one backing layer comprising a mixture of polylactic acid and an ethylene-containing copolymer comprising a polar comonomer; a tie layer disposed on the first major surface of the backing, wherein the tie layer comprises at least two different ethylene-containing copolymers each independently comprising a polar comonomer; and a release layer disposed on the tie layer, wherein the release layer comprises a polyolefin, ethylene-containing copolymer comprising a polar comonomer, a polyalkyl siloxane, a polyurethane, or a combination thereof.

### EXAMPLES

Objects and advantages of various embodiments of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Materials

| Desig- | |
|---|---|
| nation | Description |
| PLA | An amorphous polylactic acid resin having a density of 1.24 |
| | grams/cubic centimeter and a refractive index of 1.455, |
| | available under the trade designation INGEO BIPOLYMER |
| | 4060D from NatureWorks LLC, Minnetonka, MN. |
| EVA 1 | An acid/acrylate-modified ethylene/vinyl acetate polymer |
| | having 18 wt-% vinyl acetate content and a melt flow rate |
| | of 3.2 grams/10 minutes at 190° C., available under the trade |
| | designation BYNEL 3101 from DuPont Packaging and Industrial |
| | Polymers, Wilmington, DE. |
| EVA 2 | An ethylene/vinyl acetate/carbon monoxide copolymer having |
| | 10 wt-% carbon monoxide content, 24 wt-% vinyl acetate |
| | content, and a melt flow rate of 35 grams/10 minutes at 190° |
| | C., available under the trade designation ELVALOY 741 |
| | from DuPont Packaging and Industrial Polymers, |
| | Wilmington, DE. |
| LDPE 1 | A low density polyethylene resin having a density of 0.923 |
| | gram/cubic centimeter and a melt flow rate of 5.6 grams/10 |
| | minutes at 190° C., available under the trade designation |
| | PETROTHENE NA217000 from Lyondell Basell, Houston, TX. |
| Re- | See U.S. Pat. No. 9,187,678, Table 3, Example 7 for preparation |
| lease 1 | details of Release 1. |
| P77 | A masterbatch containing polyvinyl octadecyl carbamate:linear |
| | low density polyethylene (LLDPE)/20:80 (wt/wt), available |
| | under the trade designation ESOCOAT P-77 from Mayzo, |
| | Incorporated, Suwanee, GA. |
| EAA | An ethylene/acrylic acid copolymer having a density of 0.939 |
| | grams/cubic centimeter and an acrylic acid content of 9.7 wt-%, |
| | available under the trade designation PRIMACOR 3460 from |
| | Dow, Midland, MI. |
| Adhe- | A high performance acrylic adhesive having a thickness of |
| sive 1 | 0.0023 inch (58 micrometers), available as an adhesive transfer |
| | tape under the trade designation 3M High Performance |
| | Adhesive Transfer Tape 467MP with 3M Adhesive 200MP, |
| | from 3M Company, St. Paul, MN. |

Film is used here to mean a film construction that includes the combination of backing, tie layer, and release layer. These are the results reported below. Similar results were obtained on backing alone.

### Preparation of Release 1: Olefin Modified Silicone and Masterbatch Containing Same

Prepared according to U.S. Pat. No. 9,187,678, Table 3, Example 7; and Column 11, lines 24-29.

### Test Methods

All samples were conditioned in a constant temperature/humidity room at 25° C. (73° F.) and humidity (50% relative humidity) for at least 24 hours before testing.

### Tear Test

The propagation tear properties of various films were measured according to ASTM D1922 (2015): “Propagation Tear Resistance of Plastic Films and Thin Sheeting by Pendulum Method” using an Electronic Elmendorf ProTear Tester having a capacity of 200 grams (0.44 pounds), available from Thwing-Albert Instrument Company, West Berlin, N.J. Film samples having a length of approximately 7.6 centimeters (3.0 inches) and a width of approximately 6.3 centimeters (2.5 inches) were used. Some samples were cut such that the length was in the machine direction (MD) and some were cut such that the length was in the cross direction (CD). The direction of tear was perpendicular to the length. Ten samples were evaluated and the average value reported in milliNewtons (mN).

### Tensile Strength, Elongation, and Modulus

The tensile properties of various films were measured according to ASTM D3759—Procedure A (2011): “Breaking Strength and Elongation of Pressure Sensitive Tape”. Film samples having a length of approximately 22.5 centimeters (9 inches) and a width of 2.5 centimeters (1 inch) were cut in the machine direction. Testing was done using crosshead velocity setpoint of 30.0 centimeters/minute (12 inches/minute) and a Model 5900 Instron Mechanical Tester, available from Illinois Tool Works, Incorporated, Glenview, Ill. Three samples were evaluated for tensile modulus, tensile strength at failure, and tensile elongation at failure, and the average values for each property were reported.

### Haze

The haze properties of various films were measured according to ASTM D1003—Procedure A (2013): “Haze and Luminous Tranmittance of Transparent Plastics” using a BYK Gardner Haze-Gard Plus tester, available from BYK Gardner, Incorporated, Columbia, Md., and film samples measuring approximately 5.0 centimeters (2 inches) square. Three samples were evaluated and the average value reported in %.

### Peel Adhesion Strength (180 Degree Angle)

The 180 degree angle peel adhesion strengths of various films were measured according to ASTM D3330—Procedure A (2010): “Standard Test Method for Peel Adhesion of Pressure Sensitive Tape”. Stainless steel test panels were cleaned with reagent grade n-heptane, followed by methyl ethyl ketone using lint free, absorbent tissues. Tape samples measuring approximately 2.5 centimeters (1 inch) wide and approximately 20.3 centimeters (8 inches) long were cut and applied to the stainless steel test panel, then rolled down back and forth, twice in each direction, using a 2 kilogram (4.5 pound) rubber roller such that approximately 12.7 centimeters (5 inches) of the sample was in contact with the test panel. The sample was then peeled from the test panel at an angle of 180 degrees and a rate of 30 centimeters/minute (12 inches/minute) using a Model 5900 Instron Mechanical Tester (available from Illinois Tool Works, Incorporated, Glenview, Ill.). Three samples were evaluated and the average value reported in Newtons/25 millimeters (ounces/inch).

### Release Force (180 Degree Angle)

The 180 degree angle release force of various films was measured as described in the test method “Peel Adhesion Strength (180 Degree Angle)” above with the following modifications. A strip of double coated tape measuring 14.0 centimeters long by 5.1 centimeters wide (5.5 inches by 2 inches) was applied to a stainless steel test panel, then a film sample having approximately the same dimensions as the double coated tape was applied to the double coated with the release layer of the film sample facing outward. For film samples having no release surface, the film was applied with the tie layer facing outward. A piece of 3M SCOTCH PERFORMANCE FLATBACK TAPE 2525 (available from 3M Company, St. Paul, Minn.), measuring approximately 2.5 centimeters (1 inch) wide and approximately 20.3 centimeters (8 inches) long, was applied to the exposed film surface, rolled down back and forth twice in each direction using a 2 kilogram (4.5 pound) rubber roller such that approximately 12.7 centimeters (5 inches) length of the tape was in contact with the film. The tape was then peeled from the film sample.

### EXAMPLES

Film-based articles having three layers were prepared using a continuous blown film extrusion process that employed a blown film extruder having a die diameter of 10 centimeters (3.9 inches), a 1.02 millimeter (0.0040 inch) gap, and capable of extruding a film of up to 25 centimeters (9.8 inches) in diameter. The target film thickness was approximately 64 micrometers (0.0025 inch). The blown film included, in order from inside to outside, release layer, tie layer, and backing layer in a thickness ratio of 0.13:0.13:0.76, respectively.

Each layer was provided by a separate single screw extruder having a length:diameter ratio of 30:1 using the following parameters.

| | | Zone 1 | Zone 2 | Zone 3 |
|---|---|---|---|---|
| Layer | Material | ° C. (° F.) | ° C. (° F.) | ° C. (° F.) |
| Inside | Release | 166 (330) | 177 (350) | 177 (350) |
| Middle | Tie | 177 (350) | 182 (360) | 182 (360) |
| Outside | Backing | 166 (330) | 182 (360) | 182 (360) |

The three extruders fed a multilayer blown film die having a temperature of 182° C. (360° F.). The throughput of the feed extruders was set to provide the desired thickness of their respective layers and the blown film line speed was set to provide the overall film thickness.

### Examples 1-5

Examples 1-5 were prepared using the compositions shown in Table 1 below. The backing components were dry mixed and added into a first single screw extruder feeding the blown film apparatus. The tie layer components were dry mixed and added into a second single screw extruder feeding the blown film apparatus. The release layer components were dry mixed and added into a third single screw extruder feeding the blown film apparatus. For the release layer the Release 1 component was provided as a master batch of LDPE 1:Release 1/85:15/(wt/wt), prepared as described above.

### Example 6

Example 3 was repeated with the following modification. For the release layer, EVA 1 was replaced with an identical amount of LDPE 1.

### Example 7

Example 3 was repeated with the following modification. A pressure sensitive adhesive layer, having thickness of approximately 58 micrometers (0.0023 inch), was provided on the side of the film opposite that having the tie and release layers as follows. Adhesive 1, obtained in the form of an adhesive transfer tape, measuring approximately 5.1 centimeters (2 inches) wide and approximately 20.3 centimeters (8 inches) long, was applied to the film surface on the side opposite that having the release layer, rolled down back and forth twice in each direction using a 2 kilogram (4.5 pound) rubber roller. After three days at ambient conditions, the release liner was removed and the resulting single-sided pressure sensitive adhesive tape article was evaluated for peel adhesion strength as well as tear and tensile properties as described above. The 180 degree angle peel adhesion strength was 15 Newtons/25 millimeters (55 ounces/inch).

### Example 8

Example 4 was repeated with the following modification. The blend of LDPE 1 and Release 1 was replaced with the composition shown in Table 1.

TABLE 1
Film Compositions (Examples 1-8)

| Layer Composition (Weight %) | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Backing | PLA 1 | 100 | 95 | 90 | 85 | 80 | 90 | 90 | 85 |
| Layer | EVA 1 | — | 5 | 10 | 15 | 20 | 10 | 10 | 15 |
| Tie Layer | EVA 1 | 75 | 75 | 75 | 75 | 75 | 75 | 75 | 75 |
| | EVA 2 | 25 | 25 | 25 | 25 | 25 | 25 | 25 | 25 |
| Release | EVA 1 | 87 | 87 | 87 | 87 | 87 | — | 87 | — |
| Layer | Release 1 | 2 | 2 | 2 | 2 | 2 | 2 | 2 | — |
| | Total LDPE 1 | 11 | 11 | 11 | 11 | 11 | 98 | 11 | 45 |
| | P77 | — | — | — | — | — | — | — | 30 |
| | EAA | — | — | — | — | — | — | — | 25 |

### Comparative Examples

All comparative examples were produced using the same continuous blown film extrusion process as the examples. The target film thickness was approximately 64 microns (0.0025 inch) as before. The ratio of the layer thicknesses in the blown film varied when the tie layer and/or release layer were excluded. The compositions of the comparative examples is shown in Table 2.

### Comparative Example 1

Example 3 was repeated with the following modification. No tie layer was employed.

### Comparative Example 2

Example 3 was repeated with the following modification. The tie layer composition was changed to 100 weight percent of EVA 1.

### Comparative Example 3

Example 3 was repeated with the following modification. No tie layer or release layer was employed.

### Comparative Example 4

Comparative Example 1 was repeated with the following modification. The EVA 1 concentration in the release layer was reduced by 78 weight percent and replaced by an equal amount of PLA. Thus, in certain embodiments, the release layer does not include PLA.

TABLE 2
Comparative Example Film Compositions

| Layer Composition (Weight %) | | CE 1 | CE 2 | CE 3 | CE 4 |
|---|---|---|---|---|---|
| Backing Layer | PLA | 90 | 90 | 90 | 90 |
| | EVA 1 | 10 | 10 | 10 | 10 |
| Tie Layer | EVA 1 | — | 100 | — | — |
| | EVA 2 | — | — | — | — |
| Release Layer | PLA | — | — | — | 78 |
| | EVA 1 | 87 | 87 | — | 9 |
| | Total LDPE 1 | 11 | 11 | — | 11 |
| | Release 1 | 2 | 2 | — | 2 |

TABLE 3
Results

| | Film | | | | | | | |
|---|---|---|---|---|---|---|---|---|
| | Thickness | MD Tear | CD Tear | Tensile | Elonga- | | | Release |
| | (micro- | Strength | Strength | Strength | tion | Modulus | Haze | Force |
| Ex. | meters) | (mN) | (mN) | (kg/mm) | (%) | (MPa) | (%) | (kg/25 mm) |
| 1 | 59 | 172 | 202 | 0.25 | 2.7 | 1810 | 18 | 0.32 |
| 2 | 62 | 218 | 204 | 0.27 | 2.7 | 1800 | 22 | 0.29 |
| 3 | 59 | 230 | 204 | 0.25 | 2.6 | 1750 | 23 | 0.29 |
| 4 | 65 | 266 | 208 | 0.24 | 2.7 | 1610 | 21 | 0.30 |
| 5 | 53 | 298 | 200 | 0.18 | 3.2 | 1420 | 33 | 0.29 |
| 6 | 64 | 340 | 208 | 0.24 | 3.0 | 1600 | 22 | 0.30 |
| 7 | 115 | 740 | 630 | 0.40 | 3.0 | 1500 | 37 | 0.30 |
| 8 | 73 | 380 | 440 | 0.29 | 3.0 | 1500 | 36 | 0.54 |
| CE 1 | 65 | 240 | 300 | 0.27 | 2.7 | 1680 | 25 | * |
| CE 2 | 63 | 186 | 210 | 0.21 | 2.3 | 1570 | 24 | * |
| CE 3 | 62 | 268 | 228 | 0.36 | 2.8 | 2200 | 22 | 1.47 |
| CE 4 | 61 | 204 | 438 | 0.29 | 3.0 | 1920 | 31 | 0.97 |

* Release force values could not be measured for Comparative Examples 1 and 2. When the testing tape was peeled from the release surface of these film samples, the release layer began to delaminate from the backing layer.

Tear propagation characteristics in the cross direction were found to be relatively consistent for Examples 1-6. Higher values were measured for Examples 7 (adhesive layer affected results) and 8 (had a different release layer composition which contained a greater amount of LDPE). The ease of initiating tearing of the extruded film constructions in the cross direction was evaluated by hand. All examples could be initiated and torn by hand. It was observed that higher levels of EVA in the backing seemed to make it slightly more difficult to initiate the tear.

It is desirable to have a relatively low release force so that a tape made using these backings can be unrolled from itself without delamination. For example, a release force of 0.7 kg/25 mm or less would desirable, and a release force of 0.6 kg/25 mm or less would be even more desirable.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A film construction comprising:
a backing having a first major surface and a second major surface, wherein the backing comprises at least one layer comprising a polylactic acid and an ethylene-containing copolymer comprising a polar comonomer;
a tie layer disposed on the first major surface of the backing; and
a release layer disposed on the tie layer.

2. The film construction of claim 1 wherein the tie layer comprises at least two different ethylene-containing copolymers, each independently comprising a polar comonomer

3. The film construction of claim 1 wherein the release layer comprises an extrudable material.

4. The film construction of claim 3 wherein the extrudable material comprises a polyolefin, an ethylene-containing copolymer comprising a polar comonomer, a polyalkyl siloxane, a polyurethane, or a combination thereof.

5. The film construction of claim 1 wherein the release layer comprises a polyolefin.

6. The film construction of claim 5 wherein the release layer comprises a mixture comprising:
a polyolefin;
an ethylene-containing copolymer comprising a polar comonomer; and
either a polyalkyl siloxane or a polyurethane.

7. The film construction of claim 6 wherein the polyolefin in the release layer comprises a low density polyethylene.

8. The film construction of claim 6 wherein the release layer comprises a mixture comprising a polyolefin, an ethylene-containing copolymer comprising a polar comonomer, and a polyalkyl siloxane.

9. The film construction of claim 8 wherein the polyalkyl siloxane in the release layer has a structure comprising: 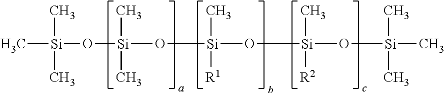
wherein:
the sum of (a+b+c) is from 100 to 1000;
the ratio of a to the sum of (b+c) is from 98:2 to 94:6;
R¹ is a linear, branched, or cyclic alkyl group having from 20 to 50 carbon atoms; and
R² is a linear, branched, or cyclic alkyl or alkaryl group having from 6 to 10 carbon atoms.

10. The film construction of claim 6 wherein the release layer comprises a mixture comprising a polyolefin, an ethylene-containing copolymer comprising a polar comonomer, and a polyurethane.

11. The film construction of claim 1 wherein the polylactic acid of the backing comprises amorphous polyactic acid and optionally semicrystalline polylactic acid.

12. The film construction of claim 1 which possesses a tearability of less than 500 milliNewtons.

13. The film construction of claim 1 which possesses a release force of 0.8 kg/25 mm or less.

14. The film construction of claim 1 which possesses an elongation of less than 5%.

15. The film construction of claim 1 which possesses a tensile strength of less than 0.54 kg/mm.

16. The film construction of claim 1 which possesses a haze value of less than 40%.

17. An article comprising the film construction of claim 1.

18. The article of claim 17 further comprising an adhesive layer disposed on the second major surface of the backing.

19. A film construction comprising:
a backing having a first major surface and a second major surface, wherein the backing comprises at least one layer comprising a polylactic acid and an ethylene-containing copolymer comprising a polar comonomer;
a tie layer disposed on the first major surface of the backing, wherein the tie layer comprises at least two different ethylene-containing copolymers, each independently comprising a polar comonomer; and
a release layer disposed on the tie layer, wherein the release layer comprises an extrudable material.

20. A film construction comprising:
a backing having a first major surface and a second major surface, wherein the backing comprises at least one layer comprising a polylactic acid and an ethylene-containing copolymer comprising a polar comonomer;
a tie layer disposed on the first major surface of the backing, wherein the tie layer comprises at least two different ethylene-containing copolymers, each independently comprising a polar comonomer; and
a release layer disposed on the tie layer, wherein the release layer comprises a polyolefin, an ethylene-containing copolymer comprising a polar comonomer, a polyalkyl siloxane, a polyurethane, or a combination thereof.
